(19) United States
(12) Patent Application Publication
(10) Pub. No.: US 2019/0092235 A1
(43) Pub. Date: Mar. 28, 2019

(54) VEHICLE DRIVING ASSISTANCE METHOD AND APPARATUS USING IMAGE PROCESSING

(71) Applicant: SAMSUNG SDS CO., LTD., Seoul (KR)

(72) Inventors: Min Kyu KIM, Seoul (KR); Sun Jin KIM, Seoul (KR); Du Won PARK, Seoul (KR); Ki Sang KWON, Seoul (KR)

(73) Assignee: SAMSUNG SDS CO., LTD., Seoul (KR)

(21) Appl. No.: 16/101,682

(22) Filed: Aug. 13, 2018

(30) Foreign Application Priority Data
Sep. 26, 2017 (KR) 10-2017-0124272

(51) Int. Cl. B60Q 9/00; G06K 9/00; G06T 7/20; G06T 7/11

(52) U.S. Cl. CPC B60Q 9/008; G06K 9/00805; G06T 2207/30261; G06T 7/11; G06T 7/20

(57) ABSTRACT

A vehicle driving assistance method is provided. The vehicle driving assistance method may comprise receiving an image of surroundings of a vehicle; receiving driving information of the vehicle; adjusting a region of interest (an ROI) in the image based on the driving information; detecting an object from the ROI; determining a probability of collision between the object and the vehicle; and outputting a signal based on the probability of collision.

This application claims priority to Korean Patent Application No. 10-2017-0124272, filed on Sep. 26, 2017, and all the benefits accruing therefrom under 35 U.S.C. § 119, the disclosure of which is incorporated herein by reference in its entirety.

### BACKGROUND

### 1. Field

The present disclosure relates to a vehicle driving assistance method and apparatus using image processing, and particularly, to a vehicle driving assistance method and apparatus using image processing, in which a region of interest (ROI) is set based on driving information of a vehicle, a moving object is detected from the ROI, the probability of collision with the detected object is determined by tracking the detected object, and the result of the determination is provided to the driver of the vehicle.

### 2. Description of the Related Art

Recently, a rapid increase in the number of vehicles has led to small and large accidents between vehicles. For this, forward collision warning (FCW) systems have been employed for many vehicles.

In a conventional collision warning method, an object in the blind spot of a vehicle is detected using a sensor mounted on the vehicle, and a notification of the detected object is sent to the side mirrors in the A-pillars or to the instrument panel.

This method, however, simply displays a warning to the driver of the vehicle based on the distance between the vehicle and the detected object without consideration of driving information of the vehicle.

Also, warning alerts using the sensor of the vehicle have a problem in that risk factors that may be present in the blind spot of the vehicle may not be able to be precisely detected, especially when lanes are being changed.

### SUMMARY

Exemplary embodiments of the present disclosure provide a vehicle driving assistance method and apparatus in which image processing is performed by setting a region of interest (ROI) based on driving information of a vehicle.

Exemplary embodiments of the present disclosure also provide a vehicle driving assistance method and apparatus in which a moving region is set based on driving information of a vehicle and the probability of collision with a moving object is determined by tracking the moving object using the moving region.

Exemplary embodiments of the present disclosure also provide a vehicle driving assistance method and apparatus in which an object region is set for an object detected and the probability of collision with the detected object is determined by measuring the size of the object region and the distance between the object region and a predetermined baseline.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present disclosure, a vehicle driving assistance method may comprise receiving an image of surroundings of a vehicle; receiving driving information of the vehicle; adjusting a region of interest (an ROI) in the image based on the driving information; detecting an object from the ROI; determining a probability of collision between the object and the vehicle; and outputting a signal based on the probability of collision. According to the aforementioned and other exemplary embodiments of the present disclosure, the probability of collision can be determined under various circumstances by setting an ROI based on driving information of a vehicle.

In addition, since the ROI can be adjusted in accordance with the driving information of the vehicle, the amount of computation in image processing can be reduced.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a block diagram of a vehicle driving assistance apparatus according to an exemplary embodiment of the present disclosure;

FIG. 2 is a flowchart illustrating a vehicle driving assistance method according to an exemplary embodiment of the present disclosure;

FIGS. 3A through 3D are schematic views for explaining an exemplary process of adjusting an ROI in an image of the surroundings in front of a vehicle based on the driving speed and the driving direction of the vehicle;

FIGS. 4A through 4D are schematic views for explaining an exemplary process of adjusting an ROI in an image of the surroundings in the rear of a vehicle based on the driving speed and the driving direction of the vehicle;

FIGS. 5A and 5B are schematic views for explaining an exemplary process of determining the probability of collision between a vehicle and a moving object detected from an image of the surroundings of the vehicle;

FIGS. 6A and 6B are schematic views for explaining another exemplary process of determining the probability of collision between a vehicle and a moving object detected from an image of the surroundings of the vehicle;

FIG. 7 is a schematic view for explaining an exemplary process of determining the probability of collision between a vehicle and an object at a short distance from the vehicle;

FIGS. 8A through 8E are schematic views for explaining an exemplary process of determining the probability of collision between a vehicle and an object at a medium distance from the vehicle;

FIGS. 9A and 9B are schematic views for explaining an exemplary process of determining the probability of collision between a vehicle and an object at a long distance from the vehicle;

FIGS. 10A and 10B are schematic views for explaining an exemplary process of detecting a moving object approaching a vehicle from a side of the vehicle from an image of the surroundings on the corresponding side of the vehicle; and

FIGS. 11A and 11B are schematic views for explaining an exemplary process of determining the probability of collision between a vehicle and a moving object detected from an image of the surroundings on a side of the vehicle.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

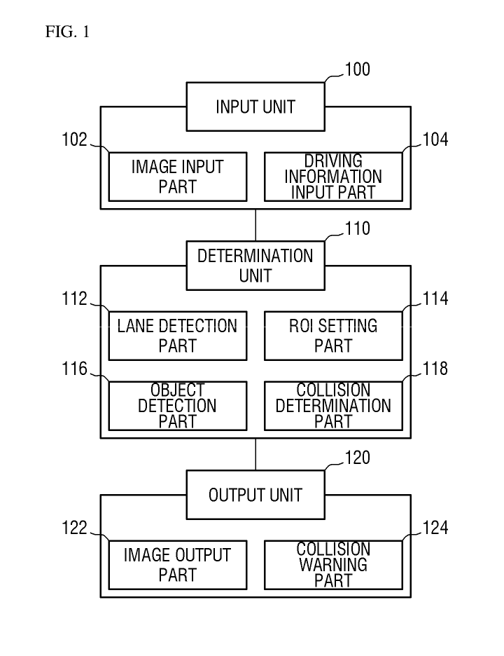

FIG. 1 is a block diagram of a vehicle driving assistance apparatus according to an exemplary embodiment of the present disclosure. The elements of the vehicle driving assistance apparatus will hereinafter be described with reference to FIG. 1.

Referring to FIG. 1, the vehicle driving assistance apparatus includes an input unit 100, a determination unit 110, and an output unit 120.

The input unit 100 includes an image input part 102 and a driving information input part 104.

The image input part 102 provides an input image of the surroundings of a vehicle to the determination unit 110. For example, the image input part 102 may include a camera module provided in the vehicle or a module receiving image data from the camera module. The input image may differ depending on the location of the camera module provided in the vehicle. For example, if the camera module is provided at the front of the vehicle, an image of the surroundings in front of the vehicle may be provided by the image input part 102. In another example, if the camera module is provided at the rear of the vehicle, an image of the surroundings in the rear of the vehicle may be provided by the image input part 102.

In one exemplary embodiment, a region of interest (ROI) may be set to precisely and quickly determine the probability of collision between the vehicle and an object. The ROI may be set based on driving information of the vehicle, input to the driving information input part 104. The driving information input part 104 may receive the driving information via an on-board diagnostics (OBD) terminal of the vehicle or from a module of the vehicle collecting and managing the driving information, such as an electronic control unit (ECU).

If the ROI is fixed, instead of being dynamically adjustable based on the driving information, the detection of an object and the prediction of the probability of collision cannot be properly performed. The ROI may be adjusted based on the driving information. Specifically, at least one of the location and the size of the ROI may be adjusted.

In one exemplary embodiment, the driving information may be information indicating the state of motion of the vehicle. Information regarding the surroundings of the vehicle is not necessarily considered the driving information. For example, the driving information may be source data from which the physical quantity of motion of the vehicle, the amount of impact on the vehicle, the direction of motion of the vehicle, and the speed of motion of the vehicle can be acquired. For example, the driving information may include the driving speed of the vehicle, the actual steering angle of the vehicle, the unloaded vehicle weight or the total weight of the vehicle, the maintenance state of the vehicle, and the driving level of the vehicle, which reflects the fatigue or driving habit of the driver of the vehicle.

In one exemplary embodiment, the driving information may include at least one of the following: the speed of the vehicle, the actual steering angle of the vehicle, the state of the surface of the road that the vehicle is running on, Global Positioning System (GPS)-based weather information of the vehicle, day/night information of the vehicle, and weight information of the vehicle.

The input unit 100 provides the driving information to the determination unit 110, and an ROI setting part 114 of the determination unit 110 sets the ROI initially and adjusts the ROI based on the driving information. A method to adjust the ROI based on the driving information will be described later in detail.

The determination unit 110 includes a lane detection part 112, the ROI setting part 114, an object detection part 116, and a collision determination part 118.

The lane detection part 112 detects lane lines from the input image provided by the input unit 100. The lane detection part 112 may use nearly any lane detection method that can be readily adopted by a person skilled in the art. The width of the ROI may be adjusted based on the detected lane lines. The ROI does not need to be set wide to detect other vehicles running between lane lines. Thus, the lane detection part 112 may detect lane lines to minimize the size of the ROI for the efficiency of image processing.

The ROI setting part 114 sets the ROI, which is a region to be subjected to image processing, to detect an object from an image of the surroundings of the vehicle and continues to adjust the ROI based on the driving information. The ROI setting part 114 sets the ROI at a position that can reflect the driving information, instead of setting the ROI simply based on image data.

In one exemplary embodiment, the driving information may be the driving speed of the vehicle. The higher the driving speed of the vehicle, the longer the braking distance of the vehicle. Thus, the ROI may be set based on the braking distance of the vehicle that varies depending on the speed of the vehicle. For example, when the speed of the vehicle is high, the braking distance of the vehicle increases, and thus, the ROI may be adjusted to extend long in the driving direction of the vehicle. On the other hand, when the speed of the vehicle is low, the braking distance of the vehicle decreases, and thus, the ROI may be adjusted to extend short in the driving direction of the vehicle.

In another exemplary embodiment, the driving information may be the actual steering angle of the vehicle. When the driver operates the steering wheel to change lanes, the probability of collision in the area towards which the vehicle is to be headed is expected to rise. Thus, the location of the ROI may be adjusted horizontally at the front or the rear of the vehicle based on the steering angle of the vehicle. For example, if the driver operates the steering wheel to the right, the ROI may be adjusted to a position extended to the right according to the outer radial direction of the actual steering angle of the vehicle.

In another exemplary embodiment, the driving information may be the unloaded vehicle weight or the total weight of the vehicle. As the unloaded vehicle weight or the total weight of the vehicle increases, the inertia of the vehicle increases, and as a result, the braking distance of the vehicle increases. The unloaded vehicle weight of the vehicle is fixed, but the total weight of the vehicle may vary depending on the number of passengers in the vehicle and the amount of cargo in the vehicle. The driving information input part 104 may provide the total weight of the vehicle to the determination unit 110. As the total weight of the vehicle increases, the braking distance of the vehicle increases, and thus, the ROI may be adjusted to extend longer in the driving direction of the vehicle.

In another exemplary embodiment, the driving information may be the maintenance state of the vehicle. The braking distance of the vehicle may vary depending on the maintenance state of the vehicle. For example, when the vehicle is in a poor condition in terms of tire air pressure or wear of tires or brake pads, the braking distance of the vehicle increases. Thus, the ROI setting part 114 may set the ROI based on the maintenance state of the vehicle. For example, when the vehicle is in a poor maintenance state, the braking distance of the vehicle increases, and thus, the ROI may be set to extend long in the driving direction of the vehicle.

In another exemplary embodiment, the driving information may be the driving level of the vehicle. The braking distance of the vehicle may vary depending on the driver's driving habit or skills. An OBD system provided in the vehicle may determine the driver's driving habit or skills. The driving information input part 104 may provide the driver's driving habit or skills, determined by the OBD system, to the determination unit 110. Then, if the driving level of the vehicle is low, a sufficient braking distance needs to be secured. Thus, when the driving level of the vehicle is low, the braking distance of the vehicle increases, and thus, the ROI may be adjusted to extend long in the driving direction of the vehicle.

In another exemplary embodiment, the driving information may be the driving level of a nearby vehicle running at the front or the rear of the vehicle. If the driving level of the nearby vehicle is low, a sufficient braking distance needs to be secured. The driving level of the nearby vehicle may be determined by detecting, through image processing, the shaking of the nearby vehicle and the number of times that the brake light of the nearby vehicle is turned on or off. Then, if a determination is made that the driving level of the nearby vehicle is low, a longer braking distance than usual needs to be secured. Thus, when the driving level of the nearby vehicle is low, the ROI may be set to extend long in the driving direction of the vehicle.

In another exemplary embodiment of the present disclosure, the driving information may be the slope of the road that the vehicle is running on. When the vehicle is running on a downhill road, the braking distance of the vehicle may increase. Thus, the ROI setting part 114 may set the ROI in consideration of the slope of the road that the vehicle is running on. For example, when the vehicle is running on a downhill road, the braking distance of the vehicle may be relatively long, and thus, the ROI may be set to extend long in the driving direction of the vehicle. On the other hand, when the vehicle is running on an uphill road, the braking distance of the vehicle may be relatively short, and thus, the ROI may be set to extend short in the driving direction of the vehicle.

In another exemplary embodiment, the driving information may be the state of the surface of the road that the vehicle is running on. Information regarding the state of the surface of the road that the vehicle is running on may be acquired by a GPS or a sensor provided in the vehicle. If the acquired information shows that the surface of the road that the vehicle is running on has a small coefficient of friction, a sufficient braking distance needs to be secured. Thus, when the surface of the road that the vehicle is running on has a small coefficient of friction, the ROI may be set to extend long in the driving direction of the vehicle. On the other hand, when the surface of the road that the vehicle is running on has a large coefficient of friction, the ROI may be set to extend long in the driving direction of the vehicle.

In another exemplary embodiment, the driving information may be weather information of the vehicle. The weather information may be acquired by the GPS of the vehicle. When it rains or snows, the surface of the road that the vehicle is running on may be slippery, and thus, a sufficient braking distance needs to be secured. Thus, when the surface of the road that the vehicle is running on is slippery, the ROI may be set to extend long in the driving direction of the vehicle.

In another exemplary embodiment, the driving information may be day/night information of the vehicle. The driver's vision may not be able to be easily secured at night as compared to during the day. Thus, at night, a sufficient braking distance needs to be secured. For example, during night driving, the ROI may be set to extend long in the driving direction of the vehicle.

The object detection part 116 detects an object from the input image and tracks the detected object. The detection and the tracking of an object by the object detection part 116 will hereinafter be described.

In one exemplary embodiment, an object may be detected based on optical flows in the input image using motion vector variations.

In another exemplary embodiment, an object may be detected by extracting the contours of the object from the input image, and then, the moving direction of the object may be predicted using a Kalman filter.

In another exemplary embodiment, an object may be detected using a learning-based histogram-of-gradient (HOG) method or a support vector machine (SVM) method.

Obviously, various means other than those set forth herein may be employed to detect and track an object.

Once an object is detected from the input image, i.e., an image of the surroundings of the vehicle, the object detection part 116 may set an object region for the detected object. The object region is a geometrical figure surrounding the detected object and is a region for determining the size of the detected object. A rectangular object region may be set to easily determine the distance between a collision baseline and the detected object, but the present disclosure is not limited thereto. The determination of the distance between the collision baseline and the detected object will be described later in detail.

The object detection part 116 may track the contours of the detected object or the object region. Since the size of the object region may change but the shape of the object region does not change, image processing can be quickly performed by tracking the object region.

The collision detection part 118 will hereinafter be described.

The collision detection part 118 determines the probability of collision between the vehicle and the detected object. The collision determination part 118 may set a moving region to determine the probability of collision between the vehicle and a moving object. The moving region is part of the input image corresponding to a future location where the vehicle is expected to be. For example, the moving region corresponds to a region set in the image to be directed to the outer radial direction of the actual steering angle of the vehicle when the driver operates the steering wheel. The probability of collision between the vehicle and the moving object can be predicted using the object region and the moving region.

In one exemplary embodiment, the speed of the detected object may be measured, and a determination may be made that there is a probability of collision between the vehicle and the detected object if the measured speed exceeds the speed of the vehicle.

In another exemplary embodiment, the probability of collision between the vehicle and the detected object may be determined by measuring a variation in the size of the detected object or the size of the object region. For example, when the size of the detected object or the object region becomes larger and larger, the detected object may probably be approaching the vehicle. Thus, the collision determination part 118 may determine that there is a probability of collision between the vehicle and the detected object.

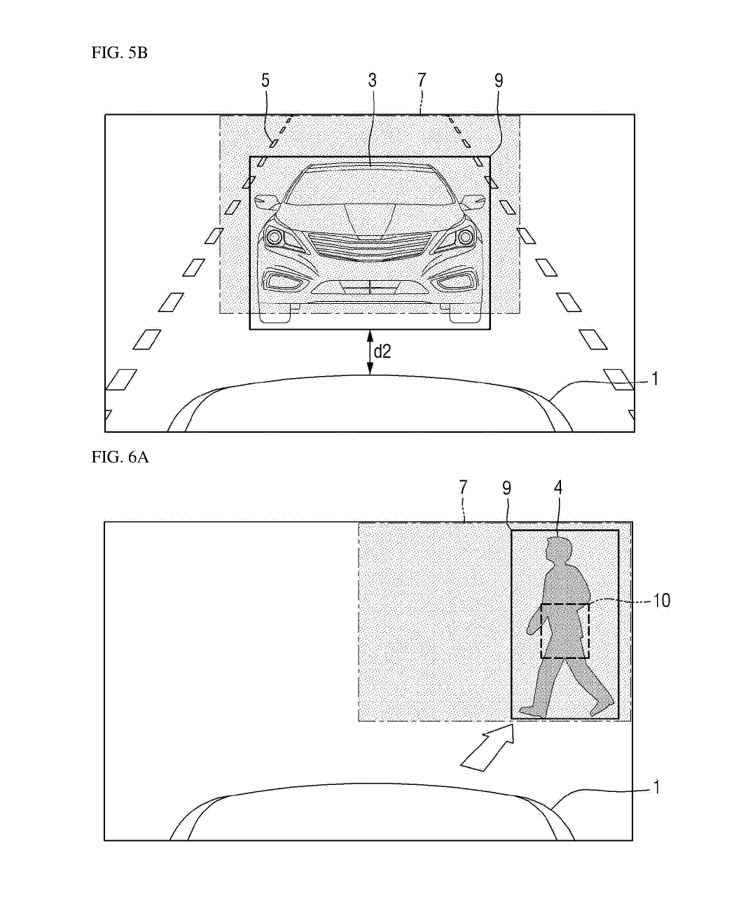

In another exemplary embodiment, the probability of collision between the vehicle and the detected object may be determined by measuring the distance between a collision baseline and the bottom of the object region, and this will be described later in detail with reference to FIGS. 5A and 5B.

In another exemplary embodiment, the probability of collision between the vehicle and the detected object may be determined using the object region and the moving region. The actual speeds of the vehicle and the detected object and the actual distances between the vehicle, the detected object, and the moving region may be measured by performing image processing on the object region and the moving region. Specifically, the speeds of the vehicle and the detected object and the distances between the detected object and the moving region and between the vehicle and the moving region may be measured. If the arrival times of the vehicle and the detected object at the moving region are expected to be the same, it means that there is a probability of collision between the vehicle and the detected object. The probability of collision between the vehicle and the detected object may be determined by predicting the movement of the detected object.

The output unit 120 includes an image output part 122 and a collision warning part 124.

The image output part 122 may output an image obtained by reflecting information provided by the driving information input part 104 into the input image provided by the input unit 100. The image output by the image output part 122 may show the ROI, the object region, and the moving region.

If the collision determination part 118 determines that there is a probability of collision, the collision warning part 124 sends a notification of a collision warning to the driver. Means for sending the notification of the collision warning includes nearly all types of means that can be readily adopted by a person skilled in the art, including voice data, sheet vibration, and image data.

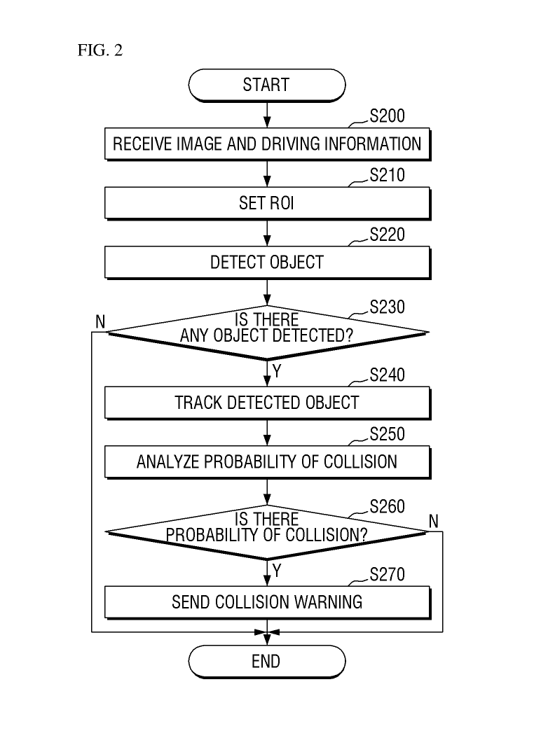

FIG. 2 is a flowchart illustrating a vehicle driving assistance method according to an exemplary embodiment of the present disclosure. The vehicle driving assistance method will hereinafter be described with reference to FIG. 2.

Referring to FIG. 2, the input unit 100 receives an input image of the surroundings of a vehicle and driving information of the vehicle and transmits the image and the driving information to the determination unit 110 (S200).

The input image may differ depending on the location of the image input part 102. For example, if the image input part 102 is a camera provided at the front of the vehicle, an image of the surroundings in front of the vehicle may be provided as the input image, if the image input part 102 is a camera provided at the rear of the vehicle, an image of the surroundings in the rear of the vehicle may be provided as the input image, and if the image input part 102 is a camera provided on a side of the vehicle, an image of the surroundings on the side of the vehicle may be provided as the input image.

Thereafter, an ROI is set in the input image (S210). The ROI is set based on the driving information to precisely and quickly determine the probability of collision. If the ROI is set arbitrarily without reflecting the driving information therein, the detection of an object and the prediction of the probability of collision may not be able to be properly performed. However, since the ROI is set to an appropriate location and size based on the driving information, the amount of computation can be reduced in the process of performing image processing to determine the probability of collision.

Once the ROI is set based on the driving information, an object is detected from the ROI (S220), and a determination is made as to whether an object has been detected (S230). As already described above, the ROI may continue to be adjusted based on the driving information.

If no object is detected from the ROI, the vehicle driving assistance method ends.

On the other hand, if an object is detected from the ROI, the detected object is tracked (S240) to determine the probability of collision. The detection and the tracking of an object will hereinafter be described.

In one exemplary embodiment, a moving object may be detected based on optical flows in the input image using motion vector variations. In another exemplary embodiment, an object may be detected by extracting the contours of the object from the input image, and then, the moving direction of the object may be predicted using a Kalman filter. In another exemplary embodiment, an object may be detected using a learning-based HOG method or an SVM method.

Obviously, various means other than those set forth herein may be employed to detect and track an object.

Once an object is detected from the input image, an object region may be set for the detected object. The object region is means for determining at least one of the location and the size of the detected object. The object region is a geometrical figure surrounding the detected object. A rectangular object region may be set to easily determine the distance between a collision baseline and the detected object, but the present disclosure is not limited thereto. The determination of the distance between the collision baseline and the detected object will be described later in detail.

The tracking of the detected object may be performed by tracking the contours of the detected object or tracking the object region. Since the size of the object region may change but the shape of the object region does not change, image processing can be quickly performed by tracking the object region.

Thereafter, the probability of collision between the vehicle and the detected object is determined (S250) by tracking the detected object.

S250 may include setting a moving region to determine the probability of collision between the vehicle and a moving object. The moving region corresponds to a region set in the image to be directed to the outer radial direction of the actual steering angle of the vehicle when the driver operates the steering wheel. The probability of collision between the vehicle and the moving object can be predicted using the object region and the moving region.

In one exemplary embodiment, S250 may be performed by measuring the speed of the detected object and determining that there is a probability of collision between the vehicle and the detected object if the measured speed exceeds the speed of the vehicle.

In another exemplary embodiment, S250 may be performed by measuring a variation in the size of the detected object or the size of the object region. For example, if the size of the detected object or the object region becomes larger and larger, the detected object may probably be approaching the vehicle. Thus, a determination is made that there is a probability of collision between the vehicle and the detected object.

In another exemplary embodiment, S250 may be performed by measuring the distance between a collision baseline and the bottom of the object region, and this will be described later in detail with reference to FIGS. 5A and 5B.

In another exemplary embodiment, S250 may be performed using the object region and the moving region. The actual speeds of the vehicle and the detected object and the actual distance between the vehicle and the detected object may be measured by performing image processing on the object region and the moving region. Specifically, the speeds of the vehicle and the detected object, the distance between the detected object and the moving region, and the distance between the vehicle and the moving region may be measured. If the arrival times of the vehicle and the detected object at the moving region are expected to be the same, it means that there is a probability of collision between the vehicle and the detected object. The probability of collision between the vehicle and the detected object may be determined by predicting the movement of the detected object.

Thereafter, a determination is made as to whether there is a probability of collision (S260).

If a determination is made that there is no probability of collision, the vehicle driving assistance method ends.

On the other hand, if a determination is made that there is a probability of collision, collision warning information is provided to the driver (S270). Specifically, the collision warning part 124 outputs a signal regarding the probability of collision between the vehicle and the detected object in accordance with the result of the determination performed in S260. Once the collision warning information is provided to the driver, the vehicle driving assistance method ends.

Means for providing the collision warning information includes nearly all types of means that can be readily adopted by a person skilled in the art, including voice data, sheet vibration, and image data.

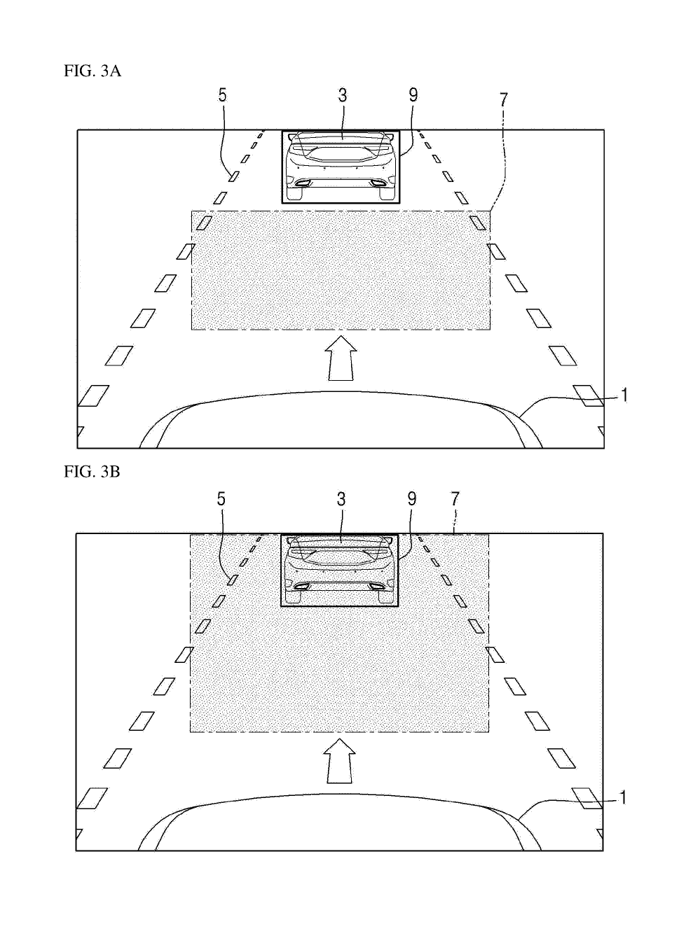

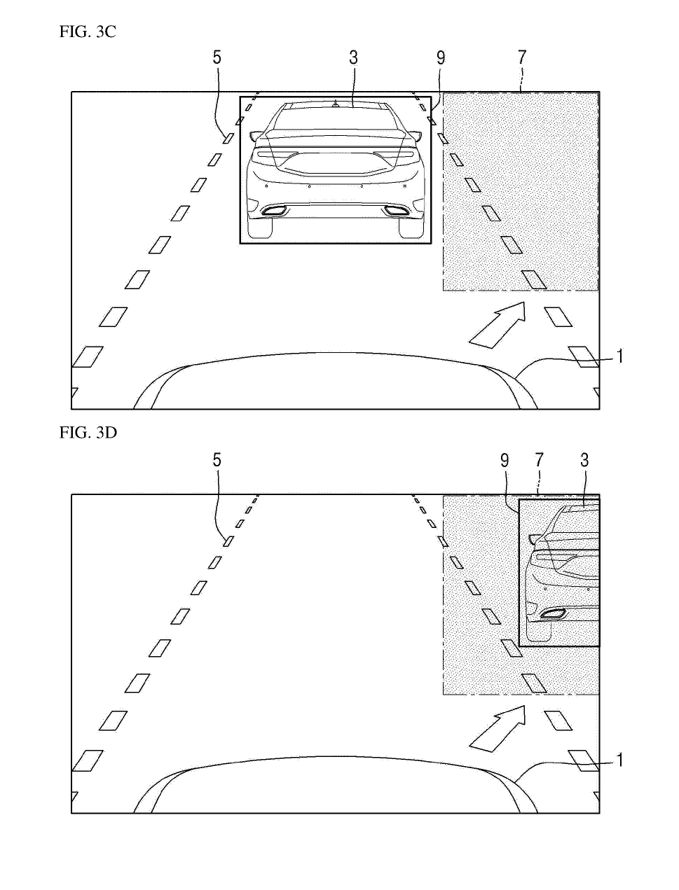

FIGS. 3A through 3D are schematic views for explaining an exemplary process of adjusting an ROI in an image of the surroundings in front of a vehicle based on the driving speed and the driving direction of the vehicle. The adjustment of an ROI will hereinafter be described with reference to FIGS. 3A through 3D.

FIG. 3A shows an image of the surroundings in front of a vehicle 1 when the speed of the vehicle 1 and the speed of a nearby vehicle 3 are relatively low. Once the image of FIG. 3A is provided to the determination unit 110, the lane detection part 112 detects lane lines 5 from the image of FIG. 3A. The width of an ROI 7 may be adjusted based on the detected lane lines 5. The ROI setting part 114 may adjust the vertical length of the ROI 7 based on speed information provided by the driving information input part 104. Specifically, when the speed of the vehicle 1 is low, the braking distance of the vehicle 1 is relatively short, and thus, the probability of collision between the vehicle 1 and the nearby vehicle 3 is relatively low. Accordingly, since the ROI 7 does not need to be set to extend long in the driving direction of the vehicle 1, the ROI 7 is set to be relatively short in the driving direction of the vehicle 1, as illustrated in FIG. 3A.

FIG. 3B shows an image of the surroundings in front of the vehicle 1 when the speed of the vehicle 1 and the speed of the nearby vehicle 3 are relatively high. Once the image of FIG. 3B is provided to the determination unit 110, the lane detection part 112 detects lane lines 5 from the image of FIG. 3B. The width of the ROI 7 may be adjusted based on the detected lane lines 5. The ROI setting part 114 may adjust the vertical length of the ROI 7 based on the speed information provided by the driving information input part 104. Specifically, when the speed of the vehicle 1 is high, the braking distance of the vehicle 1 is relatively long, and thus, the probability of collision between the vehicle 1 and the nearby vehicle 3 is relatively high. Accordingly, since the ROI 7 needs to be set to extend long in the driving direction of the vehicle 1, the ROI 7 is set to be relatively long (particularly, longer than in FIG. 3A) in the driving direction of the vehicle 1, as illustrated in FIG. 3B.

Once the ROI 7 is set, the nearby vehicle 3 is detected using the ROI 7. Once the nearby vehicle 3 is detected, the contours of the nearby vehicle 3 may be shown in the image of FIG. 3A or 3B. An object region 9 may be set to track the nearby vehicle 3. The determination of the probability of collision between the vehicle 1 and the nearby vehicle 3 with the use of the object region 9 will be described later in detail.

In an alternative example to the examples of FIGS. 3A and 3B, the ROI 7 may be set based on other driving information than the speed of the vehicle 1. For example, the other driving information may be the unloaded vehicle weight or the total weight of the vehicle 1, the maintenance state of the vehicle 1, the driving level of the vehicle 1, which reflects the fatigue or the driving habit of the driver of the vehicle 1, or the driving level of the nearby vehicle 3.

The other driving information may be the unloaded vehicle weight or the total weight of the vehicle 1, and the ROI 7 may be set based on the unloaded vehicle weight or the total weight of the vehicle 1. The larger the unloaded vehicle weight or the total weight of the vehicle 1, the longer the braking distance of the vehicle 1. Thus, when the unloaded vehicle weight or the total weight of the vehicle 1 is large, the ROI 7 may be set to extend relatively long in the driving direction of the vehicle 1.

The other driving information may be the maintenance state of the vehicle 1 (in terms of, for example, tire air pressure or wear of tires or brake pads), and the ROI 7 may be set based on the maintenance state of the vehicle 1. The poorer the maintenance state of the vehicle 1, the longer the braking distance of the vehicle 1. Thus, when the vehicle 1 is in a poor maintenance state, the ROI 7 may be set to extend relatively long in the driving direction of the vehicle 1.

The other driving information may be the driving level of the vehicle 1, which reflects the fatigue or the driving habit of the driver of the vehicle 1, and the ROI 7 may be set based on the driving level of the vehicle 1. The higher the degree of the driver's fatigue or driving skills, the slower the driver's brake response, and the longer the braking distance of the vehicle 1. Thus, when the degree of the driver's fatigue or driving skills is high, the ROI 7 may be set to extend relatively long in the driving direction of the vehicle 1.

The other driving information may be the driving level of the nearby vehicle 3, and the ROI 7 may be set based on the driving level of the driving level of the nearby vehicle 3. For example, if the nearby vehicle 3 shakes or the brake light of the nearby vehicle 3 is turned on or off too often, there may exist an unexpected probability of collision with the nearby vehicle 3. Thus, when the driving level of the nearby vehicle 3 is low, the ROI 7 may be set to extend relatively long in the driving direction of the vehicle 1.

The setting of an ROI based on the steering direction at the front of a vehicle will hereinafter be described with reference to FIGS. 3C and 3D.

FIG. 3C illustrates a case where the steering wheel of the vehicle 1 is operated to the right. If the driver of the vehicle 1 operates the steering wheel to the right, there may exist a probability of collision in a lane to the right of the current lane between the detected lane lines 5. Thus, the ROI 7 may be moved to the right in accordance with the direction to which the steering wheel is operated. Even if the ROI 7 is moved, the object region 9 may remain unmoved on the outside of the ROI 7 for use in determining the probability of collision with the nearby vehicle 3.

FIG. 3D illustrates a case where the nearby vehicle 3 is detected from the ROI 7 moved to the right. As described above with reference to FIG. 3C, the ROI 7 has been moved to the right in accordance with the direction to which the steering wheel of the vehicle 1 has been operated. Since the nearby vehicle 3 is detected from the ROI 7 moved to the right, there may be a probability of collision with the nearby vehicle 3 if the vehicle 1 moves to the right. Accordingly, the collision warning part 124 provides collision warning information to the driver of the vehicle 1.

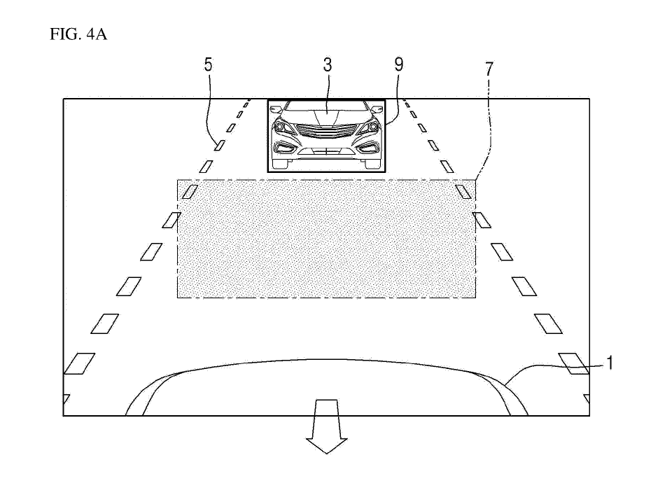

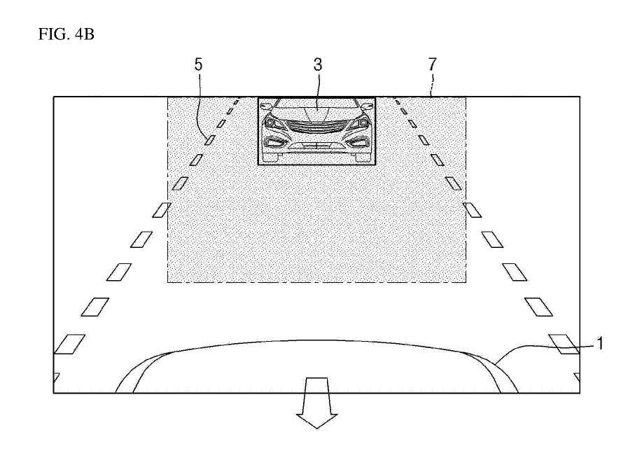

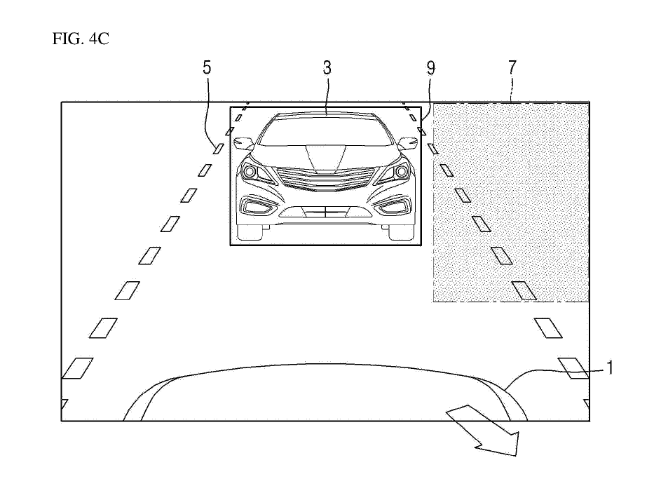

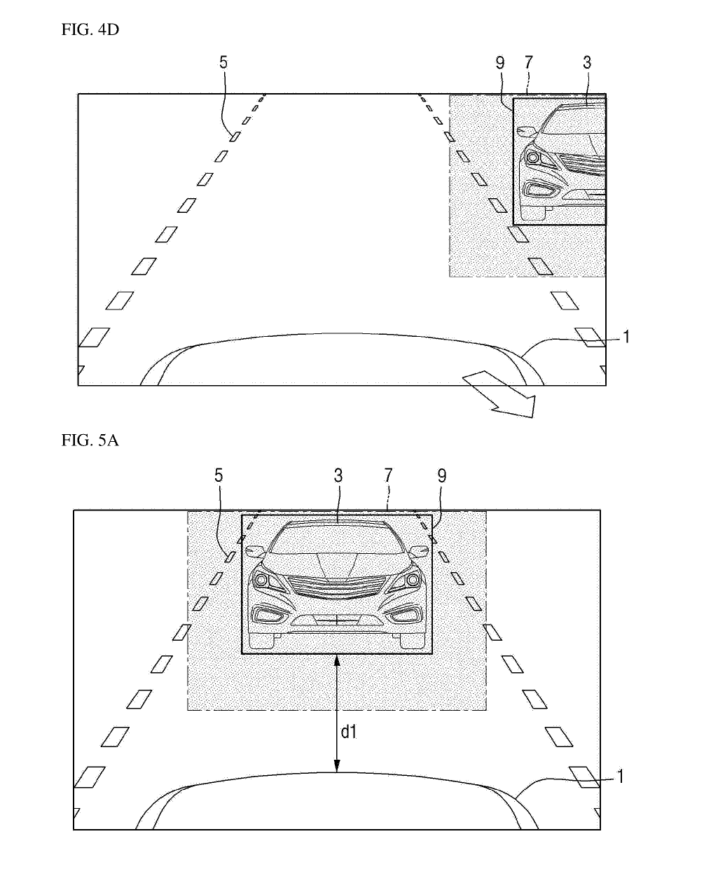

FIGS. 4A through 4D are schematic views for explaining an exemplary process of adjusting an ROI in an image of the surroundings in the rear of a vehicle based on the driving speed and the driving direction of the vehicle. The adjustment of an ROI will hereinafter be described with reference to FIGS. 4A through 4D.

FIG. 4A shows an image of the surroundings in the rear of the vehicle 1 when the speed of the vehicle 1 and the speed of the nearby vehicle 3 are relatively low. Once the image of FIG. 4A is provided to the determination unit 110, the lane detection part 112 detects lane lines 5 from the image of FIG. 4A. The width of the ROI 7 may be adjusted based on the detected lane lines 5. The ROI setting part 114 may adjust the vertical length of the ROI 7 based on the speed information provided by the driving information input part 104. Specifically, when the speed of the vehicle 1 is low, the braking distance of the vehicle 1 is relatively short, and thus, the probability of collision between the vehicle 1 and the nearby vehicle 3 is relatively low. Accordingly, since the ROI 7 does not need to be set to extend long in the driving direction of the vehicle 1, the ROI 7 is set to be relatively short in the driving direction of the vehicle 1, as illustrated in FIG. 4A.

FIG. 4B shows an image of the surroundings in the rear of the vehicle 1 when the speed of the vehicle 1 and the speed of the nearby vehicle 3 are relatively high. Once the image of FIG. 4B is provided to the determination unit 110, the lane detection part 112 detects lane lines 5 from the image of FIG. 4B. The width of the ROI 7 may be adjusted based on the detected lane lines 5. The ROI setting part 114 may adjust the vertical length of the ROI 7 based on the speed information provided by the driving information input part 104. Specifically, when the speed of the vehicle 1 is high, the braking distance of the vehicle 1 is relatively long, and thus, the probability of collision between the vehicle 1 and the nearby vehicle 3 is relatively high. Accordingly, since the ROI 7 needs to be set to extend long in the driving direction of the vehicle 1, the ROI 7 is set to be relatively long (particularly, longer than in FIG. 4A) in the driving direction of the vehicle 1, as illustrated in FIG. 4B.

Once the ROI 7 is set, the nearby vehicle 3 is detected using the ROI 7. Once the nearby vehicle 3 is detected, the contours of the nearby vehicle 3 may be shown in the image of FIG. 4A or 4B. The object region 9 may be set to track the nearby vehicle 3. The determination of the probability of collision between the vehicle 1 and the nearby vehicle 3 with the use of the object region 9 will be described later in detail.

The setting of an ROI based on the steering direction at the rear of a vehicle will hereinafter be described with reference to FIGS. 4C and 4D.

FIG. 4C illustrates a case where the steering wheel of the vehicle 1 is operated to the left. If the driver of the vehicle 1 operates the steering wheel to the left, there may exist a probability of collision in the rear of the vehicle 1 in a lane to the left of the current lane between the detected lane lines 5. Thus, the ROI 7 may be moved to the left in accordance with the direction to which the steering wheel is operated. Even if the ROI 7 is moved, the object region 9 may remain unmoved on the outside of the ROI 7 for use in determining the probability of collision with the nearby vehicle 3.

FIG. 4D illustrates a case where the nearby vehicle 3 is detected from the ROI 7 moved to the left. As described above with reference to FIG. 4C, the ROI 7 has been moved to the left in accordance with the direction to which the steering wheel of the vehicle 1 has been operated. Since the nearby vehicle 3 is detected from the ROI 7 moved to the left, there may be a probability of collision with the nearby vehicle 3 if the vehicle 1 moves to the left. Accordingly, the collision warning part 124 provides collision warning information to the driver of the vehicle 1.

FIGS. 5A and 5B are schematic views for explaining an exemplary process of determining the probability of collision between a vehicle and a moving object detected from an image of the surroundings of the vehicle. The determination of the probability of collision will hereinafter be described with reference to FIGS. 5A and 5B.

Once the nearby vehicle 3 is detected from the ROI 7, the object region 9 is set to track the nearby vehicle 3. The object region 9 may be set as a rectangle to fit the size of the nearby vehicle 3.

The probability of collision may be determined based on a variation in the size of the object region 9. The size of the object region 9 is increased from FIG. 5A to FIG. 5B, and this means that the nearby vehicle 3 is approaching the vehicle 1. Thus, the collision determination part 118 determines that there exists a probability of collision, and the collision warning part 124 provides collision warning information to the driver of the vehicle 1.

Alternatively, the probability of collision may be determined based on a variation in the distance between the bottom of the object region 9 and the vehicle 1. Referring to FIGS. 5A and 5B, the distance between the bottom of the object region 9 and the vehicle 1 is reduced from d1 to d2. As the rate at which the distance between the bottom of the object region 9 and the vehicle 1 decreases increases, the probability of collision increases. Thus, if the distance between the bottom of the object region 9 and the vehicle 1 decreases or the rate at which the distance between the bottom of the object region 9 and the vehicle 1 decreases increases, the collision determination part 118 determines that there exists a probability of collision, and the collision warning part 124 provides collision warning information to the driver of the vehicle 1.

The process of determining the probability of collision is not limited to the determination of the probability of collision between the vehicle 1 and a nearby vehicle in the rear of the vehicle 1, as illustrated in FIGS. 5A and 5B, but may also be applicable to the determination of the probability of collision between the vehicle 1 and a nearby vehicle in front of the vehicle 1.

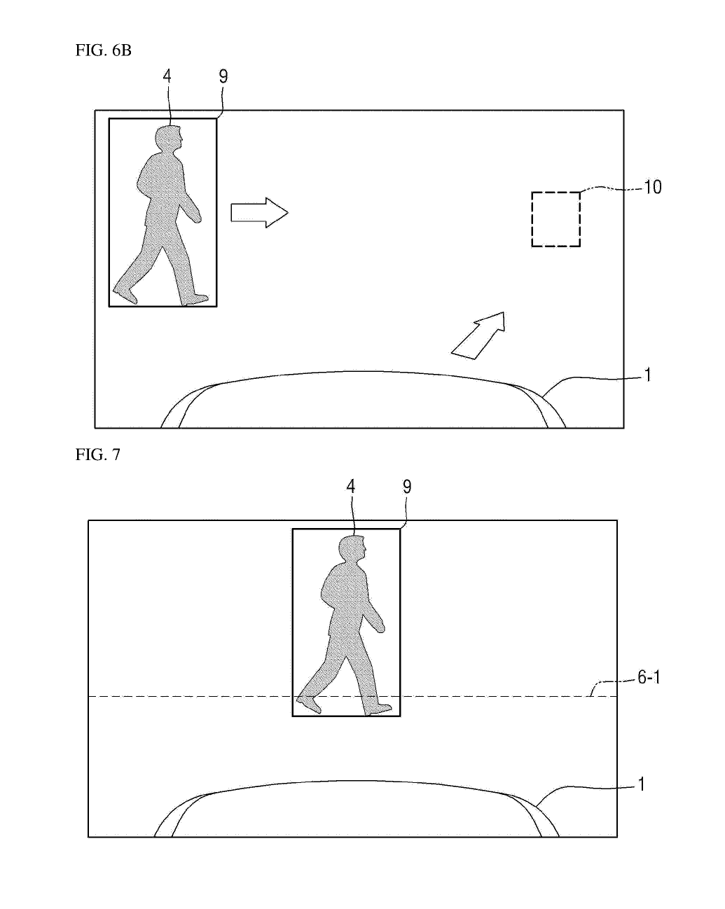

FIGS. 6A and 6B are schematic views for explaining another exemplary process of determining the probability of collision between a vehicle and a moving object detected from an image of the surroundings of the vehicle. The determination of the probability of collision will hereinafter be described with reference to FIGS. 6A and 6B.

FIG. 6A illustrates a case where the location of a moving object 4 and the location at which the vehicle 1 is headed coincide with each other. As the speed of the vehicle 1 increases, the ROI 7 is set to be larger in size and to be movable along the steering direction of the vehicle 1. A moving region 10 is set in the driving direction of the vehicle 1. The object 4 is detected from the ROI 7, and the object region 9 is set to track the object 4. The collision determination part 118 determines the probability of collision by calculating the speeds of the object 4 and the vehicle 1. If a determination is made that there exists a probability of collision between the vehicle 1 and the object 4, the collision warning part 124 provides collision warning information to the driver of the vehicle 1.

FIG. 6B illustrates a case where the location at which the object 4 is headed and the location at which the vehicle 1 is headed coincide with each other. For clarity, a detailed description of the ROI 7 will be omitted. Once the object 4 is detected, the object region 9 is set to track the object 4, and the moving region 10 is set in the steering direction of the vehicle 1. Then, the probability of collision may be determined using the object region 9 and the moving region 10. The actual speeds of the object 4 and the vehicle 1 and the distances between the object 4, the vehicle 1, and the moving region 10 may be measured by performing image processing on the object region 9 and the moving region 10. Specifically, the speeds of the vehicle 1 and the object 4 and the distances between the object 4 and the moving region 10 and between the vehicle 1 and the moving region 10 may be measured. If the arrival times of the vehicle 1 and the object 4 at the moving region 10 are expected to be the same, it means that there is a probability of collision between the vehicle 1 and the object 4. Thus, if a determination is made that there exists a probability of collision between the vehicle 1 and the object 4, the collision warning part 124 provides collision warning information to the driver of the vehicle 1.

FIG. 7 is a schematic view for explaining an exemplary process of determining the probability of collision between a vehicle and an object at a short distance from the vehicle. The determination of the probability of collision will hereinafter be described with reference to FIG. 7.

Referring to FIG. 7, a short-range baseline 6-1 may be set to determine the distance between the vehicle 1 and the object 4. The short-range baseline 6-1 is a baseline for determining whether the object 4 is in the short range of the vehicle 1. To track the object 4, the object region 9 is set. Since the object region 9 catches the short-range baseline 6-1, a determination is made that the object 4 is in the short range of the vehicle 1. Thus, the collision warning part 124 provides collision warning information to the driver of the vehicle 1.

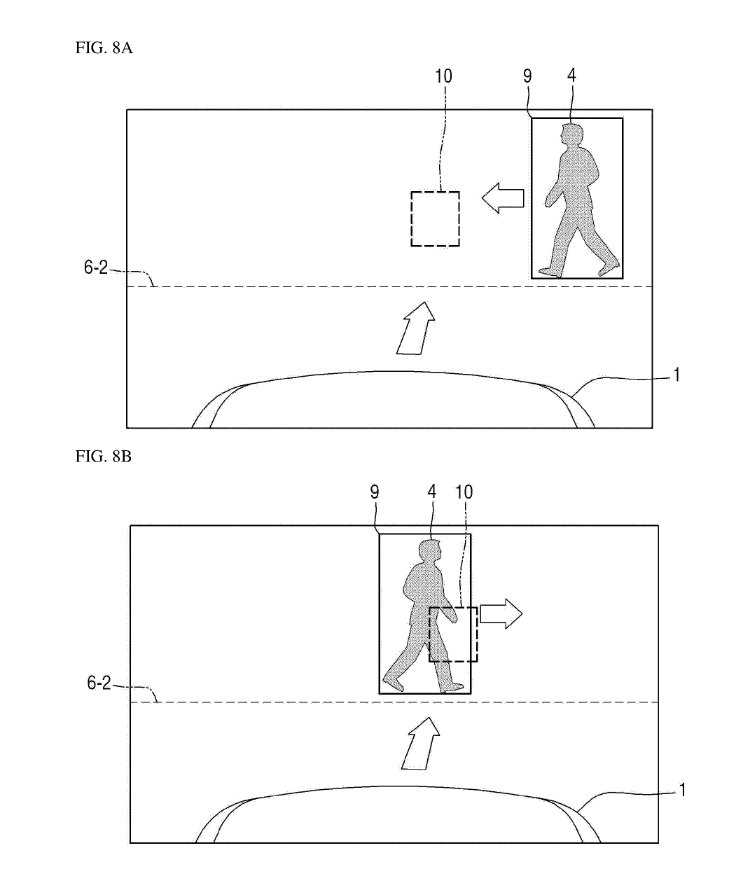

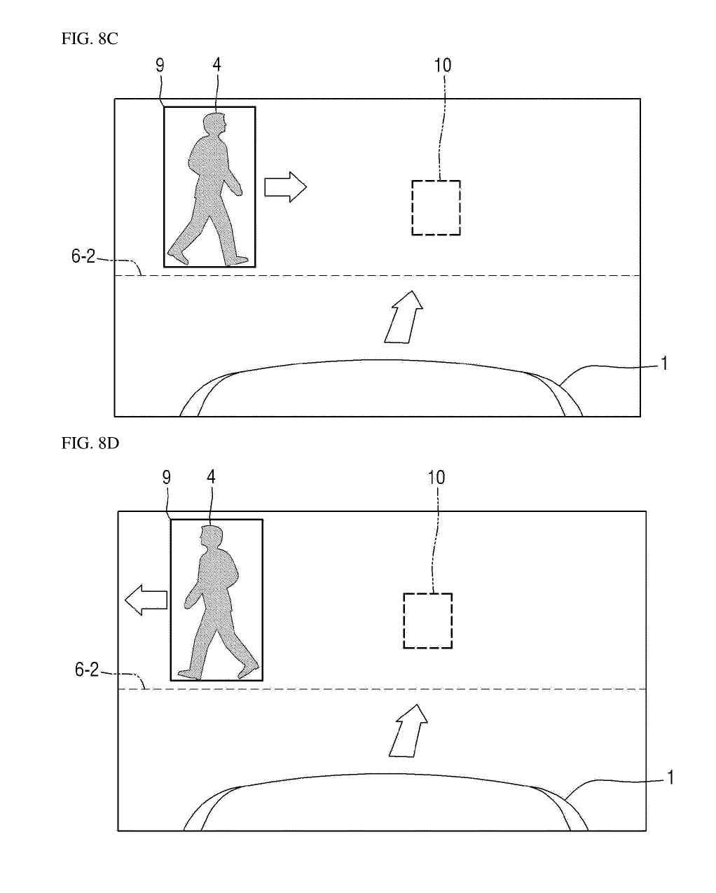

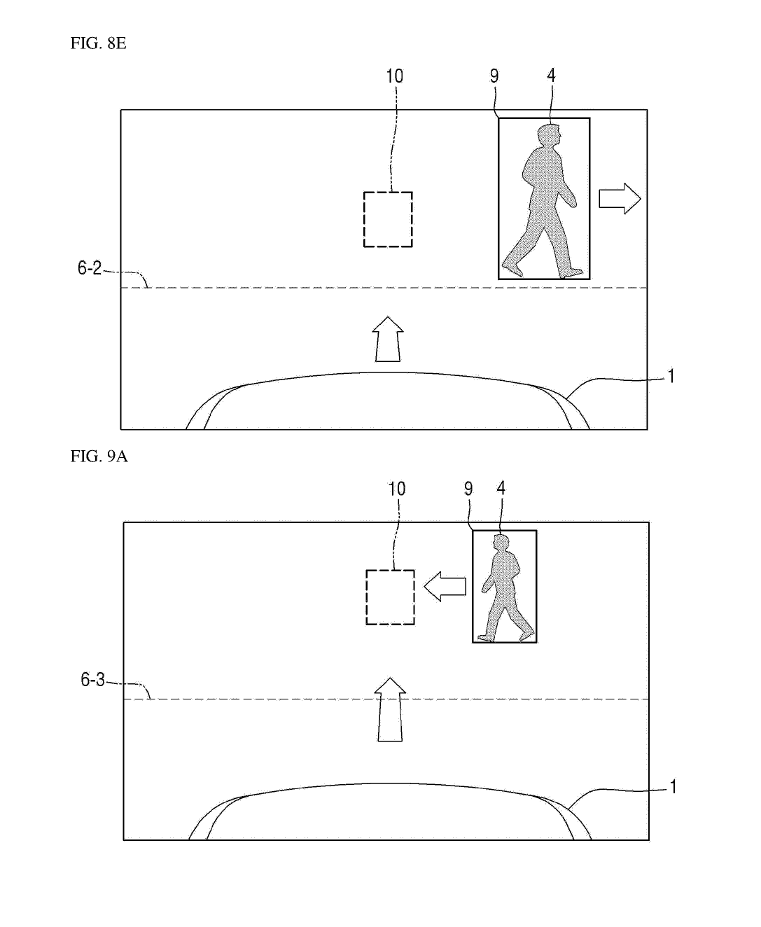

FIGS. 8A through 8E are schematic views for explaining an exemplary process of determining the probability of collision between a vehicle and an object at a medium distance from the vehicle. The determination of the probability of collision will hereinafter be described with reference to FIGS. 8A through 8E.

Referring to FIG. 8A, the moving region 10 and the location of the object 4 do not coincide with each other, but the steering direction of the vehicle 1 is directed to the moving region 10. The distance between the object 4 and the vehicle 1 may be determined based on a medium-range baseline 6-2. In this case, there exists a probability of collision between the vehicle 1 and the object 4 at a medium distance from the vehicle 1. Thus, the collision determination part 118 determines the probability of collision by measuring the speeds of the vehicle 1 and the object 4, and if a determination is made that there exists a probability of collision between the vehicle 1 and the object 4, the collision warning part 124 provides collision warning information to the driver of the vehicle 1.

Referring to FIG. 8B, the moving region 10 coincides with the location of the object 4. The steering direction of the vehicle 1 is directed to the moving direction of the object 4. In this case, there may exist a probability of collision between the vehicle 1 and the object 4 depending on the speeds of the vehicle 1 and the object 4. Thus, the collision determination part 118 determines the probability of collision by measuring the speeds of the vehicle 1 and the object 4, and if a determination is made that there exists a probability of collision between the vehicle 1 and the object 4, the collision warning part 124 provides collision warning information to the driver of the vehicle 1.

Referring to FIG. 8C, the moving region does not coincide with the location of the object, but the steering direction of the vehicle 1 is directed to the moving direction of the object 4. The example of FIG. 8C, unlike the example of FIG. 8A, corresponds to a case where the object 4 is moving very fast. In this case, there exists a probability of collision between the object 4 and the vehicle 1. Thus, the collision determination part 118 determines the probability of collision by measuring the speeds of the vehicle 1 and the object 4, and if a determination is made that there exists a probability of collision between the vehicle 1 and the object 4, the collision warning part 124 provides collision warning information to the driver of the vehicle 1.

FIGS. 8D and 8E illustrate cases where the vehicle 1 and the object 4 are unlikely to collide.

Specifically, FIG. 8D illustrates a case where the moving direction of the object 4 and the moving direction of the vehicle 1 do not coincide. Referring to FIG. 8D, the moving region is set on the right side of the vehicle 1 with respect to the medium-range baseline 6-2, and the object 4 is moving to the left at a medium distance from the vehicle 1. In this case, a determination may be made that the probability of collision with the object 4 is low.

FIG. 8E illustrates a case where the object 4 has left the moving region 10 and is thus no longer in the moving region 10. In this case, a determination may also be made that the probability of collision with the object 4 is low.

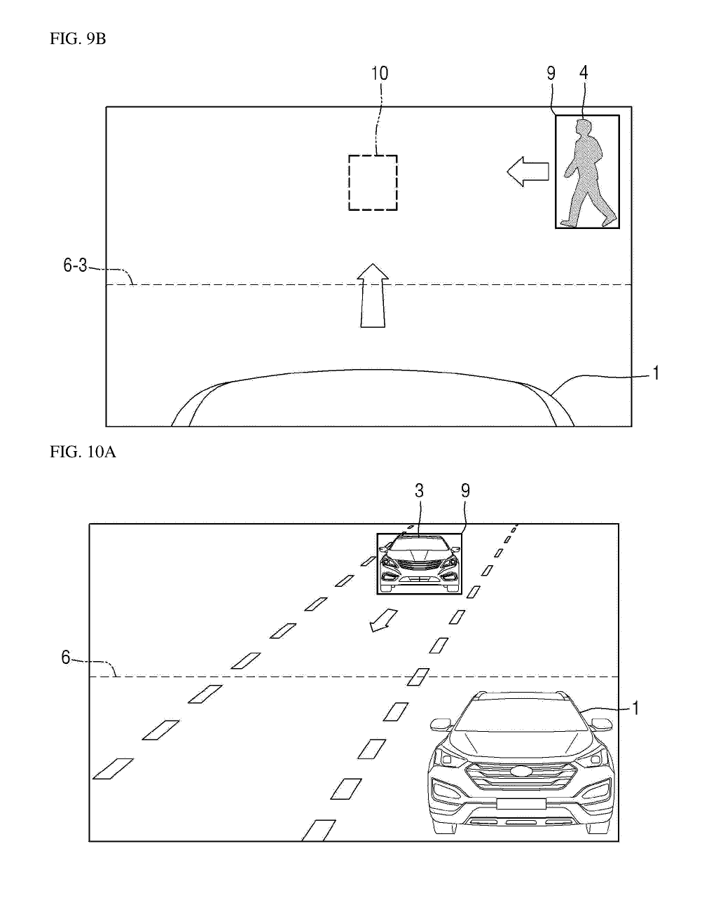

FIGS. 9A and 9B are schematic views for explaining an exemplary process of determining the probability of collision between a vehicle and an object at a long distance from the vehicle. The determination of the probability of collision will hereinafter be described with reference to FIGS. 9A and 8B.

Referring to FIG. 9A, the moving region 10 and the location of the object 4 do not coincide with each other, but the steering direction of the vehicle 1 is directed to the moving region 10. The distance between the object 4 and the vehicle 1 may be determined based on a long-range baseline 6-3. The example of FIG. 9A corresponds to a case where the object 4 is moving fast or is about to arrive in the moving region 10. In this case, the probability of collision between the vehicle 1 and the object 4 is high. Thus, the collision determination part 118 determines the probability of collision by measuring the speeds of the vehicle 1 and the object 4, and if a determination is made that there exists a probability of collision between the vehicle 1 and the object 4, the collision warning part 124 provides collision warning information to the driver of the vehicle 1.

Referring to FIG. 9B, the moving region 10 and the location of the object 4 do not coincide with each other, but the steering direction of the vehicle 1 is directed to the moving region 10. The example of FIG. 9B, unlike the example of FIG. 9A, corresponds to a case where the object 4 is moving slowly or is not about to arrive in the moving region 10. In this case, the probability of collision between the vehicle 1 and the object 4 is low. Thus, the collision determination part 118 determines that the probability of collision is low.

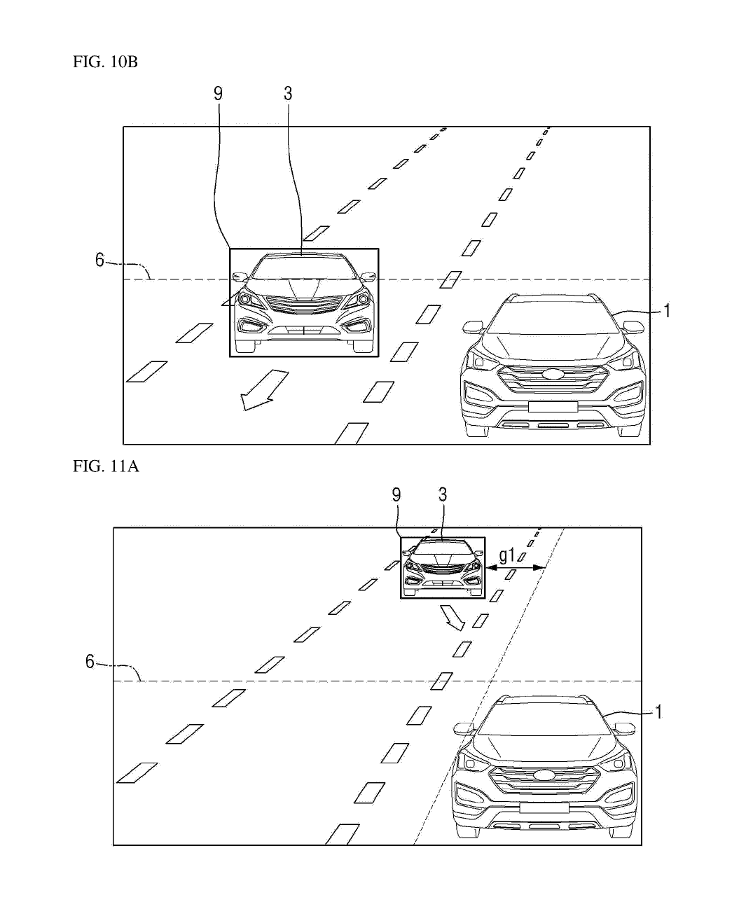

FIGS. 10A and 10B are schematic views for explaining an exemplary process of detecting a moving object approaching a vehicle from a side of the vehicle from an image of the surroundings on the corresponding side of the vehicle. The determination of the probability of collision will hereinafter be described with reference to FIGS. 10A and 10B.

Referring to FIGS. 10A and 10B, the probability of collision may be determined by measuring the size of the object region 9. A side image is provided by the image input part 102, which is provided on a side of the vehicle 1. The nearby vehicle 3 is detected from the side image, and the object region 9 is set to track the nearby vehicle 3. The collision determination part 118 tracks the object region 9 and analyzes any variations in the size of the object region 9. If the size of the object region 9 increases, a determination is made that the nearby vehicle 3 is approaching the vehicle 1. Thus, the collision determination part 118 determines the probability of collision between the vehicle 1 and the nearby vehicle 3 by measuring the size of the object region 9, and if a determination is made that there exists a probability of collision between the vehicle 1 and the nearby vehicle 3, the collision warning part 124 provides collision warning information to the driver of the vehicle 1.

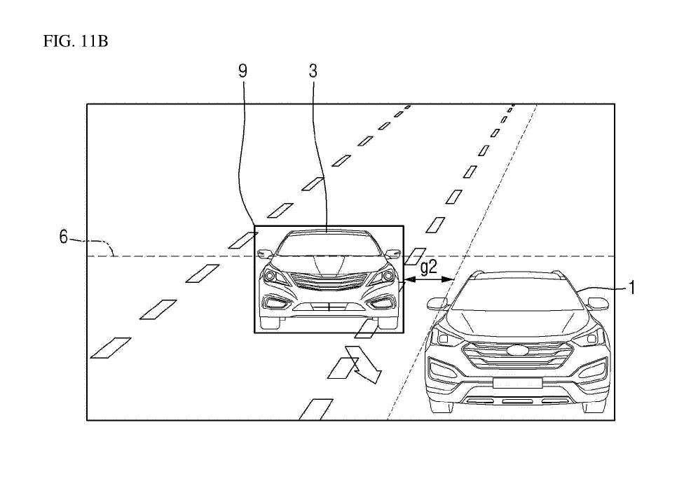

FIGS. 11A and 11B are schematic views for explaining an exemplary process of determining the probability of collision between a vehicle and a moving object detected from an image of the surroundings on a side of the vehicle. The determination of the probability of collision will hereinafter be described with reference to FIGS. 11A and 11B.

Referring to FIGS. 11A and 11B, the probability of collision is determined by measuring the distance from the vehicle 1 using both sides of the object region 9. A side image is provided by the image input part 102, which is provided on a side of the vehicle 1. The nearby vehicle 3 is detected from the side image, and the object region 9 is set to track the nearby vehicle 3. The collision determination part 118 tracks the object region 9 and measures the distance between the object region 9 and the vehicle 1. As illustrated in FIGS. 11A and 11B, the distance between the object region 9 and the vehicle 1 is reduced from g1 to g2. A decrease in the distance between the object region 9 and the vehicle 1 means an increase in the probability of collision between the vehicle 1 and the nearby vehicle 3 due to the nearby vehicle 3 approaching the vehicle 1. Thus, the collision determination part 118 determines the probability of collision between the vehicle 1 and the nearby vehicle 3 by measuring the distance between the object region 9 and the vehicle 1, and if a determination is made that there exists a probability of collision between the vehicle 1 and the nearby vehicle 3, the collision warning part 124 provides collision warning information to the driver of the vehicle 1.

The concepts of the invention described above with reference to figures can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A vehicle driving assistance method comprising:
receiving an image of surroundings of a vehicle;
receiving driving information of the vehicle;
adjusting a region of interest (an ROI) in the image based on the driving information;
detecting an object from the ROI;
determining a probability of collision between the object and the vehicle; and
outputting a signal based on the probability of collision.

2. The vehicle driving assistance method of claim 1, wherein the driving information indicates at least one among a speed, a steering angle, a surface state of a surface that the vehicle is on, Global Positioning System (GPS)-based weather information, time of day information, and vehicle weight.

3. The vehicle driving assistance method of claim 1, further comprising setting an object region for determining a size of the object in the ROI.

4. The vehicle driving assistance method of claim 3, wherein the determining the probability of collision is based on a variation in the size of the object region.

5. The vehicle driving assistance method of claim 3, wherein the determining the probability of collision is based on a distance between a bottom of the object region and a baseline set in the image.

6. The vehicle driving assistance method of claim 2, further comprising setting a moving region in the image to an outer radial direction of corresponding to a steering direction of the vehicle.

7. The vehicle driving assistance method of claim 1, further comprising setting a moving region in the image,
wherein the determining the probability of collision is based on a motion vector of contours of the object and a motion vector of the moving region.

8. The vehicle driving assistance method of claim 1, further comprising setting a moving region in the image;
setting an object region for the object; and
determining the probability of collision based on a motion vector of the object region and a motion vector of the moving region.

9. The vehicle driving assistance method of claim 1, wherein the driving information indicates a speed of the vehicle, and
wherein the adjusting the ROI comprises setting the ROI to extend longer than a first length corresponding to a driving direction of the vehicle based on the speed of the vehicle being greater than a first value, and setting the ROI to extend shorter than the first length corresponding to the driving direction of the vehicle based on the speed of the vehicle being equal to or less than the first value.

10. The vehicle driving assistance method of claim 1, wherein the driving information indicates a steering angle of the vehicle, and
wherein the adjusting the ROI comprises moving the ROI horizontally in accordance with the steering angle of the vehicle.

11. The vehicle driving assistance method of claim 1, wherein the driving information indicates a state of a surface that the vehicle is on, and
wherein the adjusting the ROI comprises extending the ROI in a driving direction of the vehicle as a coefficient of friction of the surface decreases.

12. The vehicle driving assistance method of claim 1, wherein the driving information indicates GPS-based weather information, and
wherein the adjusting the ROI comprises extending the ROI in a driving direction of the vehicle based on the GPS-based weather information indicating precipitation.

13. The vehicle driving assistance method of claim 1, wherein the driving information indicates a time of day, and
wherein the adjusting the ROI comprises extending the ROI in a driving direction based on the time of day indicating nighttime.

14. The vehicle driving assistance method of claim 1, wherein the driving information indicates vehicle weight, and
wherein the adjusting the ROI comprises extending the ROI in a driving direction based on the vehicle having a large weight.

15. The vehicle driving assistance method of claim 1, wherein the adjusting the ROI comprises adjusting at least one from among a location and a size of the ROI in the image based on the driving information.

16. The vehicle driving assistance method of claim 1, further comprising determining a size of the object,
wherein the determining the probability of collision increases as the size of the object increases.

17. The vehicle driving assistance method of claim 1, further comprising measuring a distance between a bottom of an object region for the object and a baseline set in the image,
wherein the determining the probability of collision is based on the distance.

18. The vehicle driving assistance method of claim 1, wherein the driving information indicates a state of motion of the vehicle.

19. A computer program recorded in a non-transitory recording medium, which when executed by a processor of a computing device, causes the computing device to perform a method including:
receiving an image of surroundings of a vehicle;
receiving driving information of the vehicle;
adjusting a region of interest (an ROI) in the image based on the driving information;
detecting an object from the ROI;
determining a probability of collision between the object and the vehicle; and
outputting a signal based on the probability of collision.

20. An electronic device comprising:
a memory storing one or more instructions; and
a processor configured to execute the instructions stored in the memory to:
receive an image of the surroundings of a vehicle, receive driving information of the vehicle, adjust a region of interest (an ROI) in the image based on the driving information, detect an object from the ROI, determine a probability of collision between the object and the vehicle, and output a signal based on the probability of collision.
